(19) United States
(12) Patent Application Publication
(10) Pub. No.: US 2025/0041810 A1
(43) Pub. Date: Feb. 6, 2025

(54) Capsule Gelation Device and Method for Gelling Capsules

(71) Applicant: Microcaps AG, Schlieren (CH)

(72) Inventors: Luca Di Tizio, Cham (CH); Christian Burkard, Zürich (CH); David Schaffner, Rheinfelden (CH); Morgane Roquelaure, Zürich (CH)

(21) Appl. No.: 18/714,991

(22) PCT Filed: Nov. 30, 2022
(86) PCT No.: PCT/EP2022/083786

§ 371 Date: May 30, 2024

(30) Foreign Application Priority Data
Dec. 2, 2021 (CH) CH070638/2021

(51) Int. Cl. B01F 23/41; B01F 23/43; B01F 27/116; B01F 27/95; B01F 33/81; B01F 35/33; B01J 13/04

(52) U.S. Cl. CPC B01F 23/4144; B01F 23/43; B01F 27/116; B01F 27/95; B01F 33/811; B01F 35/331; B01J 13/046

(57) ABSTRACT

Disclosed herein is a gelation device for gelling capsules. The gelation device includes a tubular column having a longitudinal axis extending along an axial direction of the tubular column a bottom portion and, a head portion. The bottom portion includes a first fluid inlet for introducing a dispersed phase into the tubular column and a second fluid inlet for introducing a continuous phase into the tubular column. The head portion includes a fluid outlet for removing gelled capsules from the tubular column and a stirring device being arranged inside the tubular column. The stirring device includes one or more stirring elements which each are longitudinally arranged inside the tubular column and which are each rotatable around the longitudinal axis of the tubular column and are configured to provide for a radial mixing of the dispersed phase and the continuous phase.

### CROSS-REFERENCE TO RELATED APPLICATIONS

This application is the United States national phase of International Patent Application No. PCT/EP2022/083786 filed Nov. 30, 2022, and claims priority to Swiss Patent Application No. CH070638/2021 filed Dec. 2, 2021, the disclosures each of which are hereby incorporated by reference in their entireties.

### BACKGROUND

### Field of Disclosure

The present invention lies in the technical field of capsule production, for example in microcapsule production, and relates to a gelation device for gelling capsules, a method for gelling capsules, a capsule production device and the use of such devices.

### Description of Art

Capsules, for example microcapsules with particle sizes of less than 3 mm, or less than 1 mm, have found widespread application in the field of pharmaceutics, cosmetics, diagnostics, food and material science. Such capsules may be produced from an emulsion of monodisperse droplets in a continuous phase. Monodispersity increases stability, allows to accurately control volumes in multiple chemical or biological reactions and enables the production of periodic structures. Microfluidics offers an exquisite platform to precisely form monodisperse droplets. The monodisperse droplets can be cured for generating microcapsules for encapsulation of active ingredients such as drugs, fragrances, flavors, peptides, living material, such as bacteria or phages etc. fertilizers, pesticides, and other active substances for well-being.

In many cases, capsule formation is performed by providing capsule forming, for example shell forming, reagents as a dispersion or emulsion of a dispersed phase in a continuous phase. Droplets are then formed, which are later cured to produce the capsules. In some examples, curing may include a change of temperature, i.e., cooling of a molten capsule forming reagent, or reacting the capsule forming reagent with another agent to form a capsule shell. A prominent example is the ion exchange of a water soluble polysaccharide salt, for example sodium alginate, with a cation, such as Ca²⁺, to form a water insoluble capsule shell. The advantage of using droplets is that the size of the droplets can be accurately controlled. A particular suitable device and method therefor is disclosed in WO 2021 037 999 A2 of the applicant, which is incorporated by reference herein in its entirety.

The actual curing step, which is typically a gelation, is often done in a batch reactor. For example, oil droplets comprising Ca²⁺ as dispersed phase in an aqueous continuous phase are guided into a batch reactor comprising an aqueous solution of sodium alginate or any other matrix forming agent to induce capsule gelling. In order to ensure homogeneity of the generated capsules and also to avoid gelling of the aqueous sodium alginate solution, the batch reactor is stirred.

A disadvantage of such a batch type gelation process is however that it is generally time consuming. Furthermore, ensuring homogeneity is often difficult to achieve, as the first droplets entering the batch reactor are in the example mentioned above exposed to a higher concentration of sodium alginate than the subsequent capsules. In addition, the first droplets are exposed for a longer time period to the sodium alginate and thus their shell will be thicker than that of subsequent droplets, respectively the capsules produced therefrom.

Another disadvantage is that growing capsules, i.e., capsules whose shell is still growing and not yet fully established, are prone to adhere to any surfaces, such as the blade surfaces of the stirrer, which reduces the homogeneity of the capsules and further may be detrimental for their structural integrity of the capsule.

### SUMMARY

It is therefore a general object of the present invention to advance the state of the art in the field of capsule production, in particular of capsule gelling, and to advantageously overcome the problems of the prior art fully or partly.

In advantageous embodiments, a gelation device and method is provided which ensures and increases homogeneity of the formed capsules. In further advantageous embodiments, a gelation device and method is provided which allows for a more efficient gelation process, which is particularly less cumbersome and less time consuming than the known batch processes. In further advantageous embodiments, a gelation device and method is provided which ensures and maintains the structural integrity of the capsules.

The general object and favorable embodiments are disclosed herein.

A first aspect of the invention relates to a gelation device for gelling capsules, for example microcapsules. The gelation device comprises a tubular column, which has a longitudinal axis which extends along an axial direction of the tubular column. Typically, the axial direction is perpendicular to the radial direction of the tubular column. The gelation device further comprises a bottom portion and a head portion. Typically, the tubular column is arranged between the bottom portion and the head portion. The bottom portion comprises a first fluid inlet which is configured for introducing a dispersed phase into the tubular column. Additionally, the bottom portion comprises another, second fluid inlet, which is configured for introducing a continuous phase into the tubular column. The head portion comprises a fluid outlet which is configured for removing gelled capsules from the tubular column. The gelled capsules are typically a dispersion in the continuous phase which is introduced into the tubular column via the second fluid inlet. The gelation device further comprises a stirring device which is arranged inside the tubular column. The stirring device comprises one or more stirring elements, which are each longitudinally arranged inside the tubular column and which are each rotatable around the longitudinal axis of the tubular column. Each stirring element is configured to provide for a radial mixing of the dispersed phase and the continuous phase, i.e., the dispersed phase being introducible via the first fluid inlet and the continuous phase being introducible via the second fluid inlet. Optionally, each stirring element is configured to essentially avoid axial mixing of the dispersed phase and the continuous phase.

It is understood that the longitudinal axis of the tubular column is arranged in the center of the tubular column. In some embodiments, the longitudinal axis has in any radial direction the same distance to the column walls.

Longitudinally arranged stirring elements are elongated along the longitudinal axis, i.e., in the axial direction of the tubular column, that is, in contrast to a radially arranged element which would be elongated along the radial direction. Typically, the extension of each stirring element in the axial direction of the tubular column is larger than the extension in the radial direction of the tubular column, for example at least 10-fold, e.g., or 20- to 30-fold, or larger. In some embodiments, each stirring element may extend essentially in parallel to the longitudinal axis of the tubular column. “Essentially in parallel” includes also stirring elements which are inclined by 10° or less, or 5° or less, with respect to the longitudinal axis of the tubular column. In some examples, the stirring elements are arranged in parallel to the longitudinal axis. Typically, the longitudinally arranged stirring elements extend in the axial direction of the tubular column.

Each stirring element may extend through the tubular column, for example in the axial direction through at least 50%, or at least 75%, or at least 85%, or at least 90%, or completely through, the tubular column.

By employing one or more stirring elements as described, the dispersed phase comprising droplets and/or capsules, for example growing or gelling capsules, are constantly kept in motion, which prevents agglomeration. Furthermore, as the dispersed phase is continuously guided through the column in its axial direction in presence of the continuous phase without axial mixing, the residence time distribution over all capsules is narrow, which ensures a uniform capsule size and quality. Additionally, employing longitudinally arranged stirring elements allows for providing a constant mixing over the column, which ensures uniformity of the capsules and also helps to prevent blockage of the column.

The tubular column is in some embodiments cylindrical. In some examples, the tubular column may define a cylindrical chamber. It is understood that the tubular column has a head opening and a bottom opening. Typically, the bottom portion of the gelation device is attached to the bottom opening of the tubular column and the head portion of the gelation device is attached to the head opening of the tubular column. It is understood that the terms “top” and “bottom” do not necessarily mean that the top portion is in the 3D space in the vertical direction (i.e., against the gravitational force vector) necessarily above the bottom portion. It is well possible to turn the device by 180° C., for example if capsules are generated which due to the density of the oil core are heavier than the continuous aqueous phase. Furthermore, it may be possible to use the device in a horizontal manner, i.e., 90° to the gravitational force vector. The tubular column has column walls, which define the column chamber, i.e., the chamber in which the stirring device is arranged. In some embodiments, the tubular column may essentially be rotationally symmetric with respect to its longitudinal axis.

In certain embodiments, each stirring element is configured such that it has a rotation path, for example a circular rotation path or an epicycloid rotation path, when it rotates around the longitudinal axis of the tubular column. In some embodiments, each rotation path of each stirring element is concentric with the column walls.

In some embodiments, the tubular column, the one or more stirring elements, the head portion and/or the bottom portion comprise, or consist of, metal, in particular steel, or of a polymer material.

In some embodiments, the length, i.e., the extension of the tubular column in the axial direction, to width, respectively the diameter, of the tubular column is at least 5:1, or at least 10:1. in some examples, the length to width of the tubular column is 5:1 and 40:1, or 10:1 and 20:1. Thus, the flow behavior within the tubular column typically resembles a pipe flow. In some examples, the length of the tubular column may in some embodiments be 5 cm to 200 cm, or 20 cm to 150 cm, or 50 cm to 100 cm. In some embodiments, the width, respectively the diameter of the tubular column is 5 mm to 200 mm, or 20 mm to 150 mm, or 50 mm to 100 mm.

In some embodiments, the stirring device, and for example the one or more stirring elements, are configured such that a radial vortex is generated when mixing the dispersed phase and the continuous phase.

In some embodiments, the stirring device comprises 1 to 24, or 2 to 24, or 3 to 18, or 6 to 12, stirring elements.

In some embodiments, the stirring elements are rods, for example straight rods. For example, the stirring elements may be cylindrical rods. It is also possible that the rods have a helical shape, i.e., they extend along the axial direction in a helical manner. In other embodiments, the stirring elements are tubes or plates.

In some embodiments, the rods may have a diameter of 1 mm to 30 mm, or 2 mm to 10 mm, or 4 mm to 8 mm.

In some embodiments, the stirring elements extend each in parallel to each other.

The gelation device may further comprise a drive unit, such as a motor, which is configured to rotate the stirring elements. In some examples, the motor may be a stepper motor.

In some embodiments, the gelation device may comprise a control unit. The control unit may be configured to control the drive unit and/or the rotation of the stirring elements, for example the rotational speed and the direction of rotation.

In some embodiments, the one or more stirring elements are free of radial surfaces. A radial surface is a surface which is arranged such that a particle being guided in the axial direction from the first or second fluid inlet to the fluid outlet through the tubular column can be retained or blocked. Such embodiments are advantageous, because any agglomeration under such surfaces is avoided, which prevents blocking and reduced capsule quality, in particular reduced homogeneity.

In some embodiments, the stirring device comprises one or more groups of stirring elements. Each of these groups comprises at least two stirring elements being arranged around a common group axis, which is arranged essentially in parallel to the longitudinal axis of the tubular column. As mentioned above, the term “essentially in parallel” includes also group axes which are inclined by 10° or lessor 5° or less, with respect to the longitudinal axis of the tubular column. Each stirring element of each group is in these embodiments additionally rotatable around the common group axis. Thus, each stirring element can undergo two rotations, namely a rotation around the longitudinal axis of the tubular column and additionally a rotation along the corresponding common group axis. In other words, the stirring elements are not only movable in the tangential direction, but also in the radial direction. Such embodiments provide for a profoundly enhanced radial mixing and thus further improves capsule homogeneity.

In certain embodiments, the gelation device further comprises a planetary gear with a sun gear being configured for rotating the stirring elements around the longitudinal axis of the tubular column and one or more planet gears being configured for rotating the at least two stirring elements of each group around the common group axis. Such a planetary gear requires only limited space.

In some embodiments, the stirring device comprises a top mounting structure and/or a bottom mounting structure, or a top mounting structure and a bottom mounting structure. A mixing space is defined between the top mounting structure and the bottom mounting structure. The top mounting structure and the bottom mounting structure have typically a cross section along the radial direction which corresponds to the cross section of the tubular column, respectively the column chamber. Typically, the top mounting structure and the bottom mounting structure are both configured such that they are rotatable within the tubular column. In certain embodiments, the top mounting structure and the bottom mounting structure are made from, or are coated with, a low surface energy material, such as polyoxymethylene or a fluorocarbon, such as polytetrafluoroethylene or any other suitable perfluorohydrocarbon material. This has the advantage that agglomeration of the formed capsules and/or the droplets in the dispersed phase is avoided.

In some embodiments, the stirring elements are mounted to and extend between the top mounting structure and the bottom mounting structure. Thus, the stirring elements protrude in the axial direction through the mixing space.

In some embodiments, the top mounting structure is convexly shaped towards the bottom mounting structure. In some embodiments, the top mounting structure has a conical shape or the shape of a spherical cap. Such a mounting structure as the advantage that the gelled capsules can be guided along the top mounting structure to the fluid outlet of head portion without being retained by a radial extending surface. Thereby, agglomeration is avoided and capsule quality is increased.

In some embodiments, the bottom mounting structure comprises one or more openings for introducing the dispersed phase and/or the continuous phase into the mixing space. In some embodiments, the bottom mounting structure has at least one opening for introducing the dispersed phase into the mixing space. Thus, the dispersed phase and/or the continuous phase may typically be guided through the bottom mounting structure. For the dispersed phase, this has the advantage that the dispersed phase does not pass any radially extending surfaces of the bottom mounting structure, which prevents agglomeration and thus ensures high capsule quality. In some embodiments, the openings may be channels. For example, the bottom mounting structure may comprise several, e.g., two or three, channels. The channels, respectively the one or more openings, may typically be through holes. In certain embodiments, the bottom mounting structure comprises one or more continuous phase openings for introducing the continuous phase into the mixing space and one or more dispersed phase opening for introducing the dispersed phase into the mixing space. It is understood that the dispersed phase openings and the continuous phase openings are typically configured such that the dispersed phase and the continuous phase are fluidic separated until they mix in the mixing space.

In some embodiments, the top mounting structure comprises one or more openings being configured for removing the gelled capsules from the mixing space. In some embodiments, the openings may be channels. For example, the bottom mounting structure may comprise several, e.g., two or three, channels. The channels, respectively the one or more openings, may typically be through holes.

In some embodiments, the tubular column comprises one or more additional fluid inlets for introducing a fluid into the tubular column. Such inlets may be arranged at the jacket of a cylindrical tubular column.

In some embodiments, the gelation device further comprises one or more inlet tubes being introduced into an opening of the bottom mounting structure. In some examples, the inlet tube protrudes from the bottom mounting structure into the mixing space, which allows to directly introduce the dispersed phase into the mixing space. Thus, such an inlet tube avoids that droplets and/or gelling or gelled capsules adhere to the bottom mounting structure.

In some embodiments, the bottom mounting structure is configured such that a gap between the tubular column and the bottom mounting structure is formed through which the continuous phase may be introduced into the mixing space. Alternatively, the continuous phase is introduced into the mixing space downstream, of the bottom mounting unit. The gap may typically be arranged circumferentially to the bottom mounting structure.

In certain embodiments, at least a part of the tubular column comprises a transparent window, which allows for observing and thus surveying the gelation process within the tubular column.

In some embodiments, the bottom portion comprises a third fluid inlet for introducing a third fluid into the tubular column. Such a third inlet may be advantageous for introducing adjuvants which support capsule gelation, for example ethanol or a shell additive, such as xanthan gum.

In some embodiments, the head portion, defines an inclined surface which is inclined with respect to the axial direction of the tubular column, in particular in an angle of >0° to <90°, or 30° to 75°, or 50° to 65°.

The inclined surface is configured such that gelled capsules are guided to the fluid outlet of the head portion.

A second aspect of the invention relates to a capsule production device, which comprises a gelation device according to any of the embodiments described herein, for example with respect to the first aspect of the invention. The capsule production device further comprises an emulsification device being configured for generating the dispersed phase and being in fluid communication with the first inlet of the bottom portion of the gelation device. Optionally, the capsule production device also comprises a continuous phase reservoir being in fluid communication with the second fluid inlet of the bottom portion of the gelation device.

The emulsification device may for example be a device as it is disclosed in WO 2021 037 999 A2 of the applicant, for example in the independent claim and the dependent claims. In some embodiments, the emulsification device may be a device for generating a dispersion of a first phase in a second phase, the emulsification device comprising a first inlet for supplying a first phase, which opens into a first chamber, a second inlet for supplying a second phase, opening into a second chamber and a dispersion outlet for collecting the dispersion. Furthermore, the emulsification device comprises a membrane, which separates the first chamber and the second chamber and which comprises a first side facing the first chamber and a second side facing the second chamber. The membrane comprises multiple channels extending from the first side to the second side, providing a fluidic connection between the first chamber and the second chamber. Each channel comprises a channel inlet arranged on the first side and a channel outlet arranged on the second side. The first chamber may be configured such that a flow rate of the first phase through all of the individual channels is essentially equal. Such an emulsification device may for example be fluidically connected via its dispersion outlet to the first fluid inlet of the bottom portion of the gelation device.

In some embodiments, the dispersion outlet of the emulsification device is directly connected to the first inlet of the bottom portion of the gelation device. In certain embodiments, a flow path from the second chamber at the dispersion outlet to the tubular column, for example to the mixing space is 5 mm to 500 mm, or 10 mm to 150 mm.

In some embodiments, the capsule production device comprises one or more additional gelation devices according to any of the embodiments described herein, for example with respect to the first aspect of the invention. In such embodiments, the gelation devices are connected in series with each other. Thus, the gelation devices are connected such that the first gelation device being in fluid connection with the emulsification device, is via its fluid outlet of its head portion in fluid connection with the first fluid inlet of the bottom portion of the second gelation device. In such a manner, multiple gelation devices can be connected in series. Thus, the dispersed phase, respectively the gelled and/or gelling capsules, are guided from the first gelation device to the second gelation device, and optionally to a third, fourth, etc. gelation device.

In some embodiments, the capsule production device further comprises a dosing unit being configured for adjusting and controlling the pressure, for example the pressure in the emulsification device, respectively the pressure at which the dispersed phase is generated in the emulsification device.

In certain embodiments, the dosing unit comprises a dosing unit inlet and a dosing unit outlet, wherein the dosing unit outlet is arranged downstream of the dosing unit inlet. Between the dosing unit inlet and the dosing unit outlet may be arranged a particle filter being configured for filtering a fluid, a gear pump, a pressure sensor and a flowmeter. In some embodiments, the particle filter is arranged downstream of the dosing unit inlet, the gear pump is arranged downstream of the particle filter, the pressure sensor is arranged downstream of the gear pump and the flowmeter is arranged downstream of the pressure sensor. Thus, in such embodiments, the order of arrangement from the dosing unit inlet to the dosing unit outlet is particle filter, then gear pump, then pressure sensor, then flow meter. Using a gear pump has the advantage that such pumps are pulsation free or at least less prone to pulsations than other pumps, in particular at low pressures. This avoids pulsations at the channels of the emulsification device, which may fluidically connect the first chamber and the second chamber as described herein.

In some embodiments, the dosing unit inlet, the particle filter, the gear pump, the pressure sensor, the flow meter, optionally the control valve, and the dosing unit outlet are linearly arranged one after another. Thus, in such embodiments, the dosing unit inlet and the dosing unit outlet are arranged at opposite ends of the dosing unit, which simplifies degassing and further reduced the dead volume of the unit.

In some embodiments, the dosing unit further comprises a control valve. The control valve may be an on-off valve. Typically, the control valve may be arranged downstream of the flowmeter and upstream of the dosing unit outlet.

In some embodiments, the flowmeter is a calibration-free flowmeter, which allows for an operation of the flowmeter which is independent of the nature of the fluid flowing there through.

In some embodiments, the pressure sensor has a resolution of 16 bit. In some embodiments, the accuracy is ±0.15 mbar.

In certain embodiments, the particle filter is configured for filtering solid particles having a particle size of 10 μm to 60 μm, or 40 μm to 60 μm or more. In some embodiments, the particle filter has a mesh size of 10 μm to 60 μm, or 40 μm to 60 μm.

It is understood that the dosing unit inlet and the dosing unit outlet are in fluid connection with each other, for example by a dosing unit tube. Furthermore, it is understood that also the particle filter, the gear pump, the pressure sensor, the flowmeter and optionally the control valve are in fluid connection with the dosing unit inlet and the dosing unit outlet, e.g., by the dosing unit tube.

A third aspect of the invention relates to a method for gelling capsules. The method includes the steps:
Providing a gelation device according to any of the embodiments as described herein, in particular with respect to the first aspect;
Introducing a dispersed phase comprising a dispersion of a core-forming emulsion which comprises oil, in an aqueous solution through the first fluid inlet of the gelation device into the tubular column of the gelation device;
Introducing a continuous phase comprising water and a matrix-forming agent through the second fluid inlet into the tubular column;
Stirring and radially mixing the introduced continuous phase and the introduced dispersed phase in the tubular column by rotating the one or more stirring elements around the longitudinal axis of the tubular column;
Transforming the matrix-forming agent in the tubular column into a solid matrix such that capsules are formed;
Removing the formed capsules from the tubular column via the fluid outlet.

The continuous phase or the dispersed phase comprises a matrix-forming agent, which is configured to form a matrix. A matrix is typically solid, for example a solid polymer network. In some embodiments, the matrix may comprise a polysaccharide, for example an ionic polysaccharide complex. in some embodiments, the matrix, for example the polysaccharide or the ionic polysaccharide complex, is water insoluble. For example, the matrix may comprise an alkaline earth metal or alkaline metal complex of a polysaccharide, such as calcium alginate, calcium carrageenan, potassium alginate or potassium carrageenan.

In some embodiments, the matrix-forming agent is a polysaccharide or suitable salt thereof. A suitable salt is a salt form which can be completely dissolved in water. Typically, polysaccharide salts are composed of an anionic polysaccharide component and a suitable counter cation. Suitable polysaccharides are selected from chitosan, cellulose, alginate, particularly sodium alginate, carrageenan, agar, agarose, pectins, gellan, starch, and the like. Preferred polysaccharides are alginate, for example sodium alginate, chitosan, carrageenan and cellulose, preferably alginate, preferably sodium alginate, chitosan. In some embodiments, the polysaccharides may be solubilized by adjusting the pH, for example by basifying the pH of the aqueous shell-forming solution.

Optionally, the continuous phase or the dispersed phase, in particular the other of the continuous phase and the dispersed phase, comprises a gelation-inducing agent. The gelation-inducing agent and the matrix-forming agent are configured such that they are capable of undergoing a chemical reaction with each other to form a water insoluble matrix, for example a matrix shell of a capsule. These may for example be configured to undergo a complexation reaction, an ion-exchange reaction or an interphase limited polymerization reaction. In such embodiments, during mixing the introduced continuous phase and the introduced dispersed phase, the gelation-inducing agent and the matrix-forming agent react with each other and form capsules of a matrix, preferably a water insoluble matrix, respectively capsules of a water insoluble matrix shell encasing an oil core.

In some embodiments, the gelation-inducing agent is an inorganic salt, for example an alkaline earth metal salt, such as an alkaline earth metal halide, an alkaline earth metal pseudohalide, an alkaline earth metal carboxylate or an alkaline earth metal nitrate, or an alkaline metal halide, an alkaline metal pseudohalide, an alkaline metal carboxylate or an alkaline metal nitrate. In some embodiments in which the gelation-inducing agent is an inorganic salt, as outlined above, the reaction in step e. between the gelation-inducing agent and the matrix-forming agent is an ion exchange reaction, i.e., an ionotropic gelation. Thus, the inorganic salt (and vice versa the matrix-forming agent) are selected such that its reaction with the matrix-forming agent results in a water insoluble reaction product. Some examples of salts, especially for polysaccharides, may thus be K, Mg, Sr or Ca salts. The skilled person understands the term “pseudohalide”, which is also referred to as “pseudohalogenide” as polyatomic analogues of halogens, whose chemistry resembles that of true halogens. Non-limiting examples include cyanide, isocyanide, cyanate, isocyanate, methylsulfonyl and triflyl. Non limiting examples of carboxylates are acetate, formate, lactate, oxalate, butyrate, succinate and the like. The gelation-inducing agent is typically selected such that it is completely soluble in water at room temperature, i.e., has a solubility in water of >10 g/100 mL, or of >20 g/100 mL, or of >50 g/100 mL. Non-limiting examples of suitable gelation-inducing agents are: CaCl₂, CaF₂, Calcium lactate, MgCl₂, Sr(OAc)₂.

The inorganic salt is typically a water soluble salt. However, it also conceivable to employ a powder of a water insoluble salt as gelation-inducing agent. For example, it may be possible to employ CaCO₃ or MgCO₃, particularly as a powder.

In some embodiments, the matrix-forming agent may be a polycarboxylate. In this case, the gelation inducing agent may be an inorganic salt as describe above which can form a water insoluble matrix upon ion exchange with the polycarboxylate. Alternatively, the gelation-inducing agent may be a polyammonium salts, i.e., a polymer comprising a plurality of polyammonium groups.

In some embodiments, the dispersed phase may be a water-in-oil-in-water emulsion. Such an emulsion may be prepared as follows:
a. Providing in a first chamber of an emulsification device a core-forming emulsion of an aqueous dispersed phase in an oil phase, the aqueous dispersed phase comprising water and a gelation-inducing agent, the emulsion further comprising a first surfactant;
b. Providing in a second chamber of an emulsification device a second aqueous solution, the aqueous solution comprising water and a second surfactant. The first chamber and the second chamber are fluidically connected by one or more channels, for example by micro-channels.
c. Guiding the core-forming emulsion of step a. from the first chamber through one or more channels into the second chamber to form a dispersion of the core-forming emulsion of step a. in the second aqueous solution of step b.

Thus, in some embodiments, the method according to the invention comprises introducing the dispersed phase comprising a dispersion (i.e., the dispersion of step c. above) of the core-forming emulsion which comprises oil and the gelation-inducing agent, in an aqueous solution through the first fluid inlet of the gelation device into the tubular column of the gelation device; and introducing the continuous phase comprising water and a matrix-forming agent through the second fluid inlet into the tubular column.

In some embodiments, rotating the one or more stirring elements around the longitudinal axis of the tubular column is performed with varying rotational speed, for example with a rotational speed that changes after each predefined time interval. Such embodiments have the advantage that the droplets, gelled capsules and/or gelling capsules are always in relative motion to each other, i.e., in contrast to stirring only with a constant rotational speed which would prevent that droplets, gelled capsules and/or gelling capsules move relative to each other, the stirring frequency may be changed at regular time intervals. In some embodiments, a change in rotational speed not only includes a decrease or increase in speed, but also a change in direction, i.e., a change of sign. For example, every time interval, e.g., every 5 seconds, the rotation direction may be switched, e.g., from clockwise to counter clockwise or from counter clockwise to clockwise. Therefore, such embodiments are particularly suitable to prevent capsule agglomeration.

In specific embodiments, the rotational speed may be controlled by the control unit as described above. Thus, the control unit may comprise a memory device which stores a function relating to the rotational speed in dependence of the process time.

In some embodiments, the mean resident time of a droplet, gelled capsule and/or gelling capsule, in the tubular column is 3 min to 40 min, or 5 min to 10 min, or 6 min to 8 min.

In some embodiments, a pressure with which the continuous phase is introduced into the gelation device is 1 bar to 6 bar, or 1 bar to 3 bar.

In some embodiment, a pressure with which the dispersed phase is introduced into the gelation device is 1 bar to 6 bar, or 1 bar to 3 bar.

A fourth aspect of the invention relates to a use of a gelation device according to any of the embodiments as described herein, for example in regard of the first aspect of the invention, for gelling capsules.

A fifth aspect of the invention relates to a use of a capsule production device according to any of the embodiments as described herein, for example in regard of the second aspect of the invention, for producing capsules.

A sixth aspect of the invention relates to a gelled capsule or an assembly of gelled capsules obtained by a method according to any of the embodiments as described herein, for example in regard of the third aspect of the invention.

A seventh aspect of the invention relates to a dosing unit being configured for adjusting and/or controlling the pressure, for example the pressure in an emulsification device, respectively the pressure at which the dispersed phase is generated in the emulsification device and/or for adjusting and/or controlling the volumetric flow, for example the volumetric flow in an emulsification device, respectively the volumetric flow at which the dispersed phase is generated in the emulsification device.

In certain embodiments, the dosing unit comprises a dosing unit inlet and a dosing unit outlet, wherein the dosing unit outlet is arranged downstream of the dosing unit inlet. Between the dosing unit inlet and the dosing unit outlet may be arranged a particle filter being configured for filtering a fluid, a gear pump, a pressure sensor and a flowmeter. In some embodiments, the particle filter is arranged downstream of the dosing unit inlet, the gear pump is arranged downstream of the particle filter, the pressure sensor is arranged downstream of the gear pump and the flowmeter is arranged downstream of the pressure sensor. Thus, in such embodiments, the order of arrangement from the dosing unit inlet to the dosing unit outlet is particle filter, then gear pump, then pressure sensor, then flow meter. Using a gear pump has the advantage that such pumps are pulsation free or at least less prone to pulsations, in particular at low pressures. This avoids pulsations at channels of the emulsification device, which may fluidically connect the first chamber and the second chamber as described herein.

In some embodiments, the dosing unit inlet, the particle filter, the gear pump, the pressure sensor, the flow meter, optionally the control valve, and the dosing unit outlet are linearly arranged one after another. Thus, in such embodiments, the dosing unit inlet and the dosing unit outlet are arranged at opposite ends of the dosing unit, which simplifies degassing and further reduced the dead volume of the unit.

In some embodiments, the dossing unit further comprises a control valve. The control valve may be an on-off valve. Typically, the control valve may be arranged downstream of the flowmeter and upstream of the dosing unit outlet.

In some embodiments, the flowmeter is a calibration-free flowmeter, which allows for an operation of the flowmeter which is independent of the nature of the fluid flowing there through.

In some embodiments, the pressure sensor has a resolution of 16 bit. In some embodiments, the accuracy is ±0.15 mbar.

In certain embodiments, the particle filter is configured for filtering solid particles having a particle size of 10 μm to 60 μm, or 40 μm to 60 μm or more. In some embodiments, the particle filter has a mesh size of 10 μm to 60 μm, or 40 μm to 60 μm.

It is understood that the dosing unit inlet and the dosing unit outlet are in fluid connection with each other, for example by a dosing unit tube. Furthermore, it is understood that also the particle filter, the gear pump, the pressure sensor, the flowmeter and optionally the control valve are in fluid connection with the dosing unit inlet and the dosing unit outlet, e.g., by the dosing unit tube.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1a a front view of a gelation device according to an embodiment of the invention;

FIG. 1b a sectional view along C-C of the gelation device shown in FIG. 1a;

FIG. 1c a front view of the gelation device of FIG. 1a, wherein the gelation column is removed;

FIG. 2 a sectional view of a head portion of a gelation device according to an embodiment of the invention;

FIG. 3 a partially exploded view of the gelation device shown in FIG. 1a;

FIG. 4 a schematic view of a capsule production device according to an embodiment of the invention;

FIG. 5 a schematic view of a portion of a gelation device according to another embodiment of the invention;

FIG. 6 a perspective view of a dosing unit according to an aspect of the invention.

### DETAILED DESCRIPTION

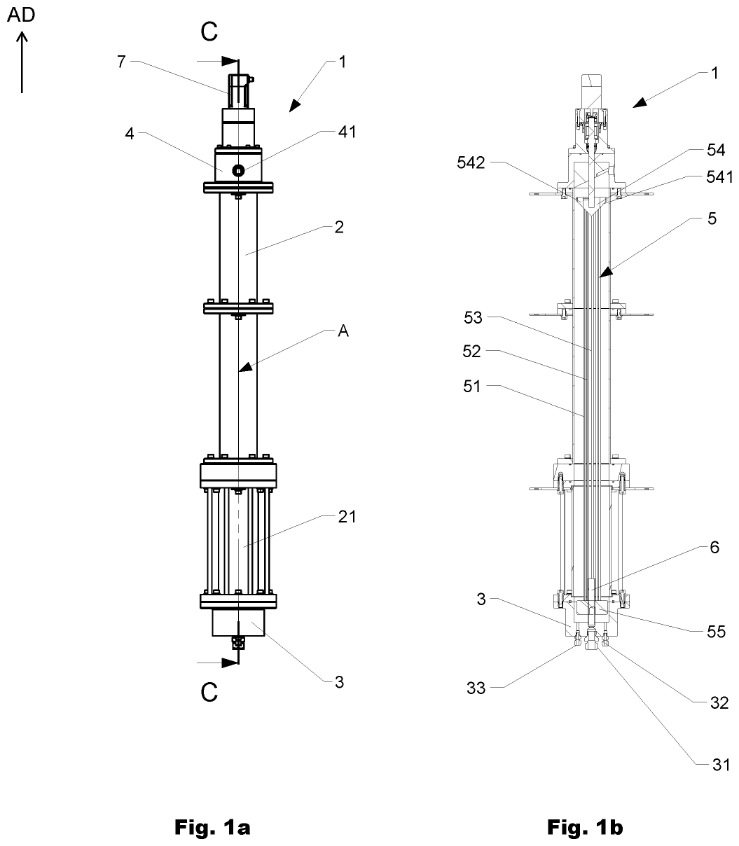

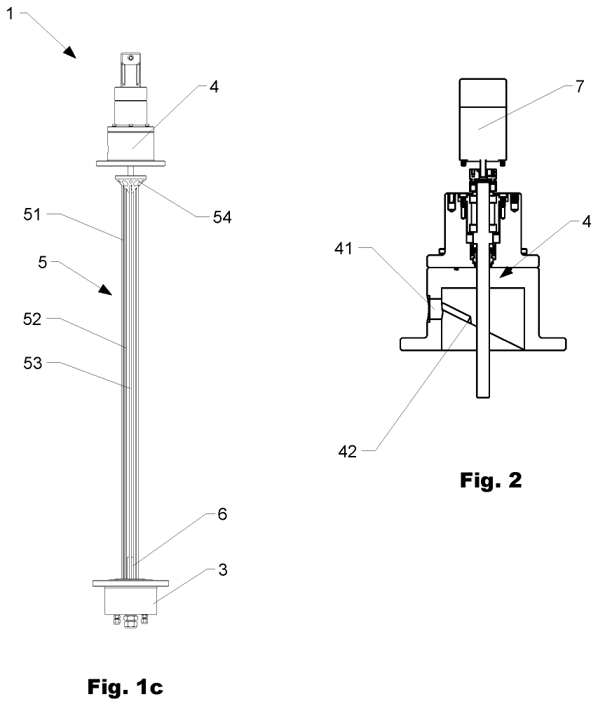

FIG. 1a shows a front view of gelation device 1 for gelling capsules. Gelation device 1 comprises tubular column 2, which has a longitudinal axis A extending along axial direction AD. Gelation device 1 further comprises bottom portion 3 and head portion 4 between which tubular column 2 is arranged. Head portion 4 contains fluid outlet 41 via which the gelled capsules can be removed from the gelation device. Furthermore, tubular column 2 comprises transparent window 21 through which allows to observe the gelation process inside tubular column 2. Drive unit 7 is arranged adjacent to head portion 4 and is used to rotate the stirring elements (not shown in FIG. 1a).

FIG. 1b. is a sectional view of FIG. 1a along C-C. As can be seen, gelation device 1 further comprises stirring device 5 which is arranged inside tubular column 2. The stirring device comprises multiple stirring elements 51, 52, 53 (only three stirring elements are referenced for clarity purposes), which in this embodiment are straight rods. As can be seen, the stirring elements are each longitudinally arranged, i.e., they extend along axial direction AD. The stirring elements are rotatable around the longitudinal axis A (see FIG. 1a) of tubular column 2. Stirring device 5 further comprises top mounting structure 54 and bottom mounting structure 55, which define a mixing space between them. As can be seen, stirring elements 51, 52, 53 of the stirring device 5 are mounted to top mounting structure 54 and are also mounted to bottom mounting structure 55. Thus, also the top mounting structure and the bottom mounting structure are generally rotatable around the longitudinal axis of tubular column 2. Bottom portion 3 of gelation device 2 comprises a first fluid inlet 31 for introducing a dispersed phase into tubular column 2 and particularly into the mixing space between top mounting portion 54 and bottom mounting portion 55. First fluid inlet 31 is in fluid communication with inlet tube 6 of gelation device 2, which is guided through an opening in bottom mounting structure 55 and which protrudes from bottom mounting structure 55 into the mixing space defined between top mounting structure 54 and bottom mounting structure 55. Furthermore, as can be seen, to mounting structure 54 is convexly shaped towards bottom mounting structure 55, i.e., seen from bottom mounting structure 55 along axial direction AD. In this particular embodiment, top mounting structure 54 comprises a conical shape with a conical tip pointing towards bottom mounting structure 55. In addition, top mounting structure 54 comprises openings 541, 542, which protrude top mounting structure 54 and which are configured form guiding gelled capsules towards fluid outlet 41.

FIG. 1c shows the gelation device 1 of FIG. 1a, however the tubular column is removed to depict the inner setup of the device.

FIG. 2 shows a sectional view of head portion 4 and drive unit 7 as they are for example used in the gelation device depicted in FIG. 1a-c. Head portion 4 comprises, respectively defines, inclined surface 42 which is configured such that gelled capsules are guided to fluid outlet 41 of head portion 4. In this embodiment, surface 42 is inclined with respect to longitudinal axis A (see FIG. 1a) of tubular column 2 in an angle of about 60°. This has the advantage that gelled capsules are not forced on a pure radial surface, i.e., a surface which would be aligned in a 90° angle towards longitudinal axis A, which prevents capsule damage and further allows to efficiently degas tubular column 2 before gelation commences, as remaining gas bubbles rise in the axial direction and are then guided to outlet 41 by surface 42.

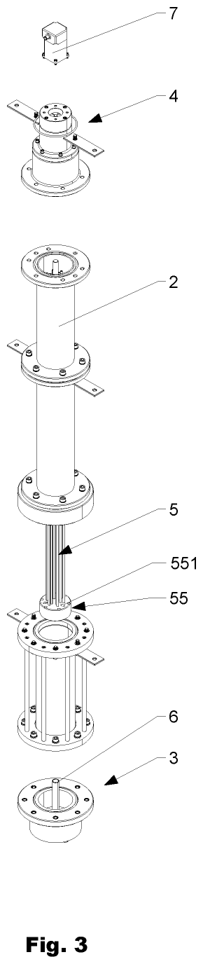

FIG. 3 shows a partially exploded view of gelation device 1 shown in FIG. 1a-c. Bottom mounting structure 55 of stirring device 5 comprises in addition to the dispersed phase opening through which inlet tube 6 is guided and which is in fluid communication with first inlet 31 of bottom portion 3 (see FIG. 1b), multiple continuous phase openings 551 (only one continuous phase opening is referenced for clarity purposes), which are in fluid connection with second fluid inlet 32 of bottom portion 3 and which are configured to introduce the continuous phase into the mixing space between the top mounting structure and the bottom mounting structure of stirring device 5.

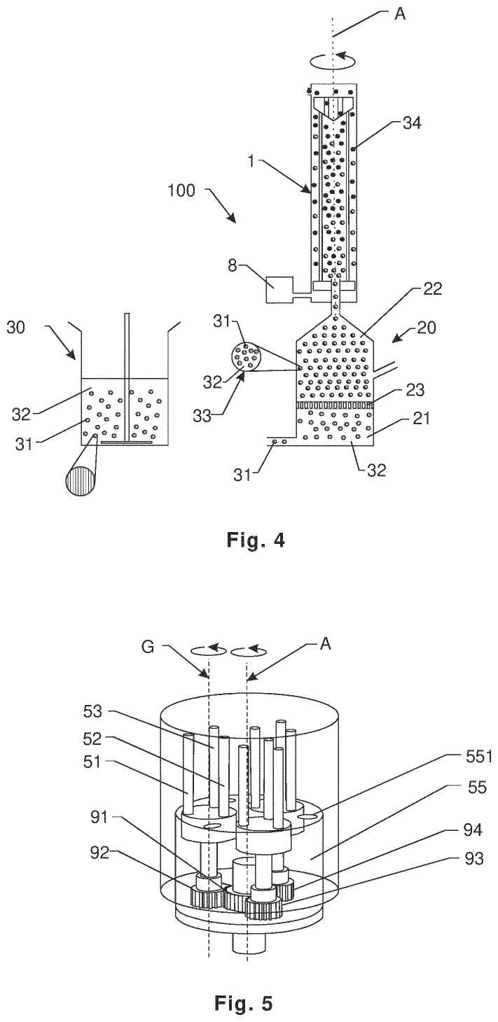

FIG. 4 shows a capsule production device 100 comprising a gelation device 1 as described in any of the embodiments herein, for example a device as depicted in FIG. 1a-c, and an emulsification device 20, which is configured for generating the dispersed phase and which is in fluid communication with, i.e., which is fluidically connected to, with the first inlet of the bottom portion of the gelation device 1. Capsule production device 1 further comprises continuous phase reservoir 8 which is fluidic connected to the second inlet of the bottom portion of gelation device 1. Capsules can for example be produced with such a device as follows:

In a first step, a core forming emulsion is generated by mixing a solution 31 comprising a gelation inducing agent, a surfactant and water with oil phase 32 (left side of the figure). This may for example be done with a stirrer. The figure on the left shows a vessel with droplets 31 and also an enlarged view of a selected droplet 31 of solution in the emulsion. The straight lines of the droplets represent droplets comprising water and dissolved therein the gelation inducing agent, for example an inorganic salt A⁺B⁻. Thus every droplet 31 shown is an aqueous solution of the gelation inducing-agent. The formed emulsion of the aqueous solution 31 of the gelation-inducing agent in oil phase 32 is then provided into first chamber 21 of emulsification device 20 via a corresponding inlet. Second chamber 22 of the emulsification device comprises a second aqueous solution comprising water and a surfactant. This second aqueous solution may be provided via the shown inclined inlet of the second chamber 22. As can be seen, first chamber 21 and second chamber 22 are fluidic connected by multiple channels 23. In the embodiment shown, the first chamber and the second chamber are separated by membrane whose first side faces towards the first chamber and whose second side faces towards the second chamber. Channels 23 extend from the first side towards the second side. In general, a suitable pressure is applied on core-forming emulsion in first chamber 21. The emulsion in first chamber 21 is then guided through channels 23. As the emulsion generally comprises as the major component the oil phase 32, a step emulsification takes place as the emulsion reaches the channel outlet opening into second chamber 22, thereby forming a dispersion of the core forming emulsion, i.e., monodisperse droplets 33 in the second aqueous phase. It should be noted that the sizes of the droplets are exaggerated for clarity purposes. Furthermore, the relative size of droplets 31 with respect to droplets 33 does not resemble the reality. Each monodisperse droplet 33 in second chamber 22 now comprises one or more droplets 31 being dispersed in oil phase 32, as it illustrated in the enlarged view of droplet 33. Thus the dispersion in second chamber 22 may be considered as a “water in oil in water emulsion”. This dispersion is provided via the dispersion outlet of emulsification device 20 into gelation device 1 via the first fluid inlet of the corresponding bottom portion. A further continuous phase is provided from reservoir 8 via corresponding second fluid inlet of the bottom portion of gelation device 1 into its tubular column. The dispersed phase coming from the emulsification device is then mixed with the continuous phase from reservoir 8, which is an aqueous shell forming solution comprising water and a water soluble and dissolved matrix-forming agent, for example sodium alginate. When the dispersion of the core forming emulsion, i.e., monodisperse droplets 33 in the second aqueous phase is mixed with the aqueous shell forming solution by rotating the stirring elements around longitudinal axis A of the tubular column (see arrow), the gelation-inducing agent, e.g., Ca²⁺ within droplets 33 diffuses towards the droplet surface and then chemically reacts at the interface with the matrix-forming agent to form a water insoluble matrix shell, which fully grows around each droplet thereby forming capsules 34 of a water insoluble matrix shell encasing an oil core. The gelled capsules are filled in black color, while the half-filled circles in gelation device 1 represent droplets 33 or currently still gelling capsules. These capsules then rise and are removed via the fluid outlet from gelation device 1.

FIG. 5 shows a schematic view of a portion of a gelation device according to another embodiment of the invention. The shown gelation device comprises three groups of stirring elements, which each comprises three stirring elements 51, 52, 53 (for clarity purposes, only the stirring elements 51, 52, 53 of the first of the three groups are referenced). The three stirring elements of each group are arranged around common group axis G and are configured such that each stirring element 51, 52, 53 of each group is rotatable around common group axis G. Furthermore, each group as a whole and also each stirring element is rotatable around longitudinal axis A of the tubular column. Within bottom portion 3, the gelation device comprises a planetary gear having sun gear 91 which is configured for rotating the stirring elements around the longitudinal axis A of the tubular column and further three planet gears 92, 93, 94 which are each configured for rotating the three stirring elements 51, 52, 53 of each group around their corresponding common group axis G.

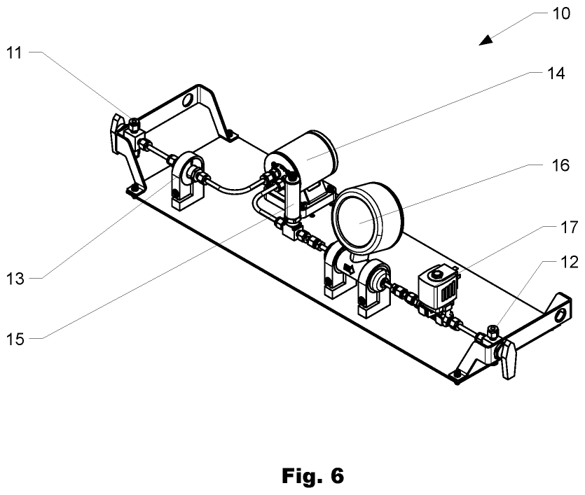

FIG. 6 shows dosing unit 10 as it can be used in a capsule production device according to an embodiment of the invention. Dosing unit 10 comprises dosing unit inlet 11 and a dosing unit outlet 12 which are in fluid connection by a dosing unit tube. As can be seen, dosing unit outlet 12 is arranged downstream of dosing unit inlet 11. Between dosing unit inlet 11 and dosing unit outlet 12 is particle filter 13 being configured for filtering a fluid flowing through the dosing unit tube, gear pump 14, pressure sensor 15 and flowmeter 16. Furthermore, arranged downstream of flowmeter 16 and upstream of dosing unit outlet 12 is control valve 17. When being used in a capsule production device as described herein (see FIG. 4), then the dosing unit outlet is typically connected to the inlet of the first chamber 21 (see FIG. 4) of the emulsification device. Thus, the dosing unit may provide droplets 31 being dispersed in oil phase 32 (see FIG. 4) to the first chamber 21 of emulsification device 20.

1. A gelation device for gelling capsules, the gelation device comprising:
a. a tubular column having a longitudinal axis extending along an axial direction of the tubular column;
b. a bottom portion and a head portion, wherein the bottom portion comprises a first fluid inlet for introducing a dispersed phase into the tubular column and a second fluid inlet for introducing a continuous phase into the tubular column, and wherein the head portion comprises a fluid outlet for removing gelled capsules from the tubular column;
c. a stirring device being arranged inside the tubular column, the stirring device comprising one or more stirring elements which each are longitudinally arranged inside the tubular column and which are each rotatable around the longitudinal axis of the tubular column and are configured to provide for a radial mixing of the dispersed phase and the continuous phase.

2. The gelation device according to claim 1, wherein the one or more stirring elements are rods or plates.

3. The gelation device according to claim 1, wherein the one or more stirring elements are free of radial surfaces.

4. The gelation device according to claim 1, wherein the stirring device comprises one or more groups of stirring elements, wherein each group comprises at least two stirring elements being arranged around a common group axis being parallel to the longitudinal axis of the tubular column and wherein each stirring element of each group is rotatable around the common group axis.

5. The gelation device according to claim 4, further comprising a planetary gear with a sun gear being configured for rotating the stirring elements around the longitudinal axis of the tubular column and one or more planet gears being configured for rotating the at least two stirring elements of each group around the common group axis.

6. The gelation device according to claim 1, wherein the stirring device further comprises a top mounting structure and a bottom mounting structure and wherein a mixing space is defined between the top mounting structure and the bottom mounting structure.

7. The gelation device according to claim 6, wherein the stirring elements are mounted to and extend between the top mounting structure and the bottom mounting structure.

8. The gelation device according to claim 6, wherein the top mounting structure is convexly shaped towards the bottom mounting structure.

9. The gelation device according to claim 6, wherein the bottom mounting structure comprises one or more openings for introducing the dispersed phase and/or the continuous phase into the mixing space.

10. The gelation device according to claim 9, further comprising an inlet tube being introduced into one of the openings of the bottom mounting structure.

11. The gelation device according to claim 6, wherein the bottom mounting structure is configured such that a gap is formed through which the continuous phase can be introduced into the mixing space.

12. The gelation device according to claim 1, wherein at least a part of the tubular column comprises a transparent window.

13. The gelation device according to claim 1, wherein the bottom portion comprises a third fluid inlet for introducing a third fluid into the tubular column.

14. A capsule production device comprising:
a. a gelation device according to claim 1; and
b. an emulsification device being configured for generating the dispersed phase and being in fluid communication with the first inlet of the bottom portion of the gelation device;
c. optionally a continuous phase reservoir being in fluid communication with the second fluid inlet of the bottom portion of the gelation device.

15. The capsule production device according to claim 14, further comprising one or more additional gelation devices connected in series with each other.

16. The capsule production device according to claim 14, further comprising a dosing unit being configured for adjusting and/or controlling the pressure in an emulsification device.

17. A method for gelling capsules, the method comprising the steps:
providing a gelation device according to claim 1,
introducing a dispersed phase comprising a dispersion of a core-forming emulsion which comprises oil, in an aqueous solution through the first fluid inlet of the gelation device into the tubular column of the gelation device;
introducing a continuous phase comprising water and a matrix-forming agent through the second fluid inlet into the tubular column;
wherein the continuous phase or the dispersed phase comprises a matrix-forming agent configured to form a matrix;
stirring and radially mixing the introduced continuous phase and the introduced dispersed phase in the tubular column by rotating the one or more stirring elements around the longitudinal axis of the tubular column;
transforming the matrix-forming agent in the tubular column into a solid matrix such that capsules are formed; and
removing the formed capsules from the tubular column via the fluid outlet.

18. The method according to claim 17, wherein rotating the one or more stirring elements around the longitudinal axis of the tubular column is performed with varying rotational speed.

19. (canceled)

20. (canceled)
